(19) United States
(12) Patent Application Publication
(10) Pub. No.: US 2007/0211147 A1
(43) Pub. Date: Sep. 13, 2007

(54) IMAGE CAPTURE SYSTEMS AND METHODS

(75) Inventors: Wei Sheng Tseng, Kaohsiung City (TW); Ming Chih Yuan, Taoyuan County (TW); Ming Te Liu, Taipei City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/683,359

(22) Filed: Mar. 7, 2007

(30) Foreign Application Priority Data
Mar. 8, 2006 (TW) TW95107761

(51) Int. Cl. H04N 5/225; G03B 19/00; H04N 5/228; G03B 17/48; G03B 29/00

(52) U.S. Cl. 348/207.1; 396/429; 348/222.1

(57) ABSTRACT

An image capture system capable of a plurality of image capture processes is equipped with a button on its surface and a storage device storing a predetermined folder. When the button is activated, the system determines the active window thereof and automatically performs one of the capture processes based on the determination, thus an image shown on a display is captured and stored in the predetermined folder.

### BACKGROUND OF THE INVENTION

1. Field of the Invention

The present invention relates to computer techniques, and more particularly to image capture.

2. Description of the Related Art

Various buttons on a computer are designed for quick start of user routines. For example, a Print Screen button on a keyboard is utilized to capture an image of a full screen of a computer when pressed. Occasionally, a print screen operation is followed by a step of pasting the capture image to an application, such as the Microsoft Painter or others, so that the captured image can be stored as a file for some other purpose. Although the Print Screen button is provided, further several manual operations are required.

Further, various launch keys on a notebook computer are designed for launching applications, such as web browser, email editor, and other user-defined applications. Actually, a launch key act as a Quick Launch button provided by Microsoft OSes. From the perspective, the Quick Launch button offers the choice of initiating an application through a mouse operation. When launch keys are utilized to assist in a print screen operation, manual operations for image pasting, folder selection, and file naming are still required.

### BRIEF SUMMARY OF THE INVENTION

An exemplary embodiment of an image capture system capable of a plurality of image capture processes comprises a button, a display, a storage device, and a capture unit. The button is disposed on a surface of the image capture system. The display can show at least one window of a program executed by the image capture system. The storage device coupled to the button and the display stores a predetermined folder. When the button is activated, the capture determines an active window of the image capture system and automatically performs a corresponding process selected from the image capture processes based on the determination, thus an image shown on the display is captured and stored in the predetermined folder.

An exemplary embodiment of an image capture system capable of a plurality of image capture processes comprises an input device, a display, a storage device, and a capture unit. The input device triggers an image capture request. The display can show at least one window of a program executed by the image capture system. The storage device coupled to the input device and the display stores a predetermined folder. When receiving the image capture request, the capture unit determines whether an active window of the image capture system belongs to a first predetermined application of a plurality of predetermined applications, and, if so, utilizes an image capture function provided by the first predetermined application of the active window to capture and store an image shown on the display in the predetermined folder.

An exemplary embodiment of an image capture method is provided. A predetermined folder and a plurality of image capture processes are stored in an image capture system. When the image capture system receives an image capture request, an active window of the image capture system is determined. A corresponding process is automatically selected from the image capture processes and performed based on the determination, thus an image shown on a display is capture and stored in the predetermined folder.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of an exemplary embodiment of an image capture system;

FIG. 2 is a schematic view showing a button disposed on the image capture system;

FIG. 3 is a flowchart showing an exemplary embodiment of an image capture method; and

FIG. 4 is a schematic diagram of an active window and an image capture area.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

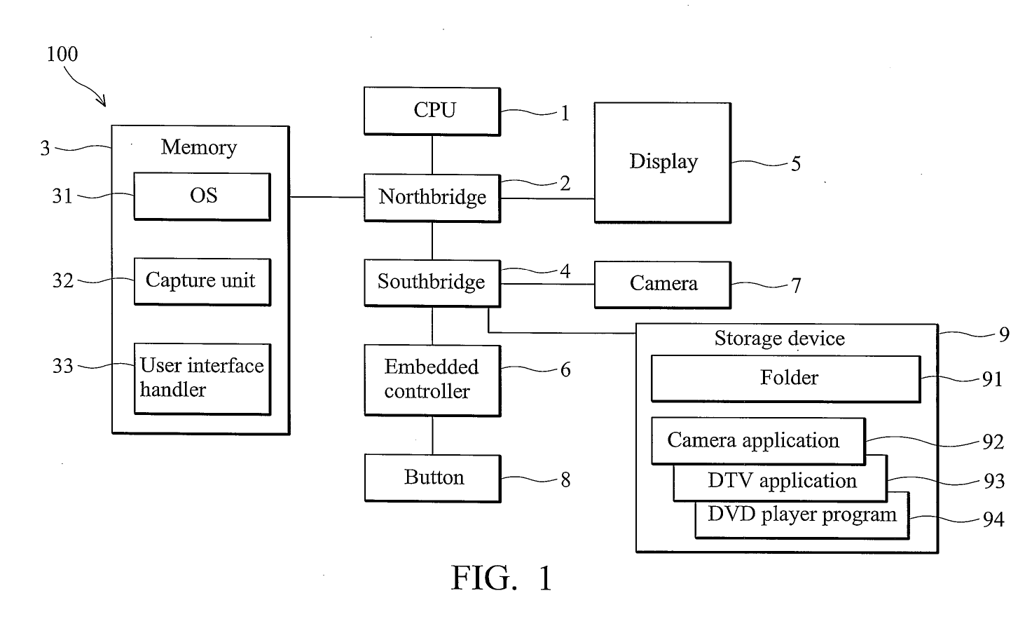

Image capture systems and methods are provided. With reference to FIG. 1, image capture system 100 capable of a plurality of image capture processes comprises central processing unit (CPU) 1, Northbridge 2, memory 3, Southbridge 4, display 5, embedded controller 6, camera 7, button 8, and storage device 9. Note that embodiments of the image capture systems may be implemented by different hardware configuration. For example, any couple or all of CPU 1, northbridge 2, memory 3, southbridge 4, and embedded controller 6 may be integrated into a single chip. Button 8 may also be replaced by other input devices, such as touch panels, optical switches or voice control devices. An image capture system may comprise a personal computer, a notebook, a personal digital assistant (PDA), a global positioning system (GPS) receiver, a mobile phone, or another electronic device. Southbridge 4 and camera 7 may be coupled through a universal serial bus (USB).

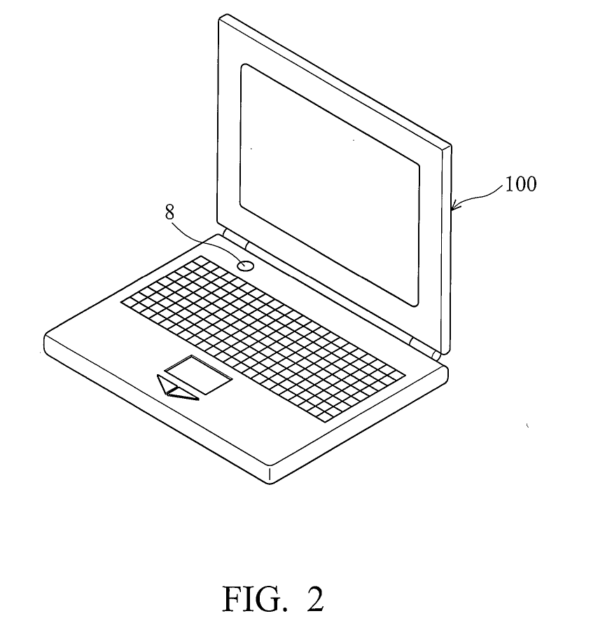

Button 8 is disposed on a location (as shown in FIG. 2, but not limited thereto) of a surface of image capture system 100. Embedded controller 6 detects the status of button 8 and accordingly generates a corresponding signal (such as an image capture request described in the following) according to the status of button 8.

Display 5 can display windows of programs executed in image capture system 100. Storage device 9 stores a predetermined folder for storage of images, applications, operating system (OS) 31, and capture unit 32. The applications may comprise digital versatile disc/disk (DVD) player application 94, digital TV (DTV) application 93, camera application 92 for displaying realtime image data captured by a digital camera, and other video player programs.

An application may allocate a plurality of sub windows in a main window, but only a sub window displays desired document content to be captured while other sub-windows may comprise authoring tools or other information. Some applications, such as DVD player applications, have built-in image capture functions that display media content as video overlay which cannot be extracted by common image capture applications. Using a generic image capture process to capture images may be problematic in these situations. Thus, a plurality of image capture processes are provided to deal with different conditions in a computer system.

When button 8 is activated, capture unit 32 determines an active window of image capture system 100 and automatically performs a corresponding process selected from the image capture processes based on the determination, thus an image shown on display 5 is captured and stored in predetermined folder 91. Each of a plurality of predetermined applications may correspond to one of the image capture processes which may be implemented by different modules of computer programs. Different image capture processes may respectively comprise different schemes or steps for image capture and determination process of target areas comprising desired images to be captured. A corresponding image capture process may also be utilized in a situation where image capture system 100 has no active window.

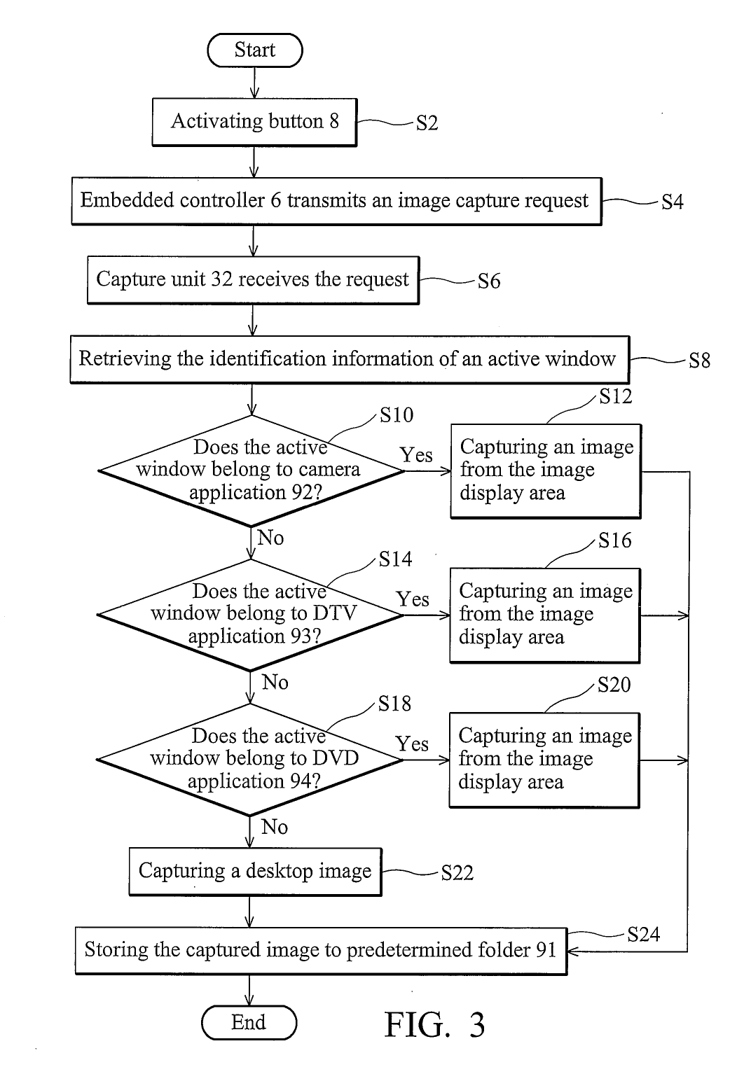

With reference to FIG. 3, an exemplary embodiment of an image capture method is provided. When button 8 is activated (step S2), embedded controller 6 transmits a corresponding signal as an image capture request (step S4). Capture unit 32 receives the request (step S6) and identification information of an active window of image capture system 100, and accordingly determines the application of the active window (step S8). Capture unit 32 determines whether the active window belongs to a first predetermined application of the predetermined applications, and, if so, performs a corresponding process selected from the image capture processes. Capture unit 32 may comprise a computer program module of the corresponding image capture process and utilize the module to perform the image capture. Alternatively, capture unit 32 may transmit a virtualized signal to trigger an image capture function built in the first predetermined application. Capture unit 32 then retrieves and stores a captured image in predetermined folder 91. The following steps are incorporated with certain predetermined applications, but are not limited thereto. The so-called predetermined applications may comprise other applications.

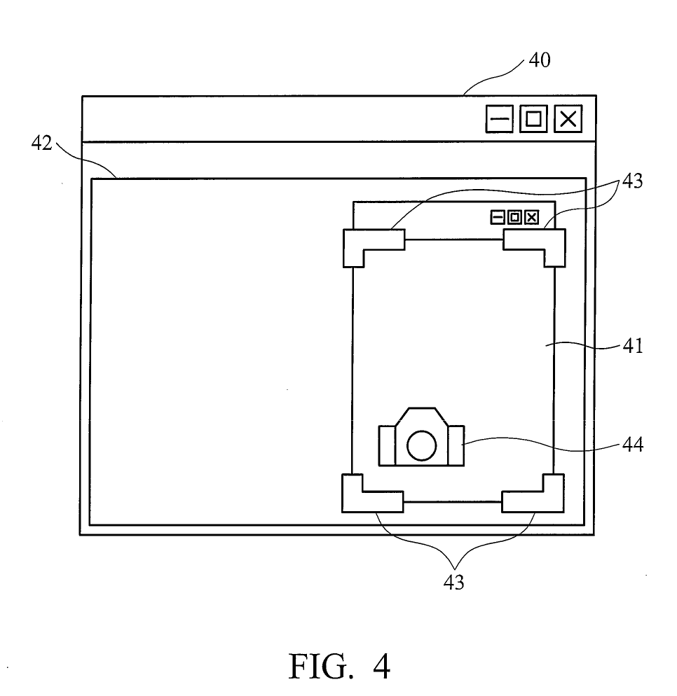

When the active window of image capture system 100 belongs to a predetermined application, capture unit 32 captures and stores an image from an image display area of the active window in the predetermined folder 91. For example, capture unit 32 determines if the active window of image capture system 100 belongs to camera application 92 (step S10). With reference to FIG. 4, camera application 92 displays realtime image data captured by camera 7 in image display area 41 of window 40. When the active window of image capture system 100 comprises window 40, as a window of camera application 92, capture unit 32 captures (step S12) and stores the image within image display area 41 in predetermined folder 91 (step S24). During progression of the image capture, user interface handler 33, may display frame 43 around the border of image display area 41 shown on the display to mark a captured image area, and plays an animation 44 via on screen display (OSD) to represent the progression of the image capture. User interface handler 33 may also output an audible alert through a speaker (not shown) of image capture system 100 to notify the execution of the image capture.

Capture unit 32 may utilize a customized module to retrieve the class name of window 40, and thereby retrieve the range of image display area 41. Alternatively, when the application of the active window has an image capture function, capture unit 32 may utilize the image capture function (for example, by invoking a subroutine of the function) to perform image capture and store the captured image in predetermined folder 91. Thus, capture unit 32 can determine the range of an image display area before capturing an image. Without image display area identification capability, a conventional image capture program extracts pixels in area 42.

Capture unit 32 determines whether the active window of image capture system 100 belongs to DTV application 93 (step S14). When the active window of image capture system 100 belongs to DTV application 93, capture unit 32 captures (step S16) and stores an image from an image display area of the active window in predetermined folder 91 (step S24). DTV application 93 may comprise a special area as the image display area thereof. Similarly, capture unit 32 may utilize a customized module or a built-in function of DTV application 93 to retrieve a class name of a window of DTV application 93, and thereby retrieve the range of the image display area to perform image capture.

Capture unit 32 determines whether the active window of image capture system 100 belongs to DVD player application 94 (step S18). When the active window of image capture system 100 belongs to DVD player application 94, capture unit 32 captures (step S20) and stores an image from an image display area of the active window in predetermined folder 91 (step S24). Similarly, capture unit 32 may utilize a customized module or a built-in function of DVD player application 94 to retrieve a class name of a window of DVD player application 94, and thereby retrieve the range of the image display area to perform image capture. Examples of the DVD player application 94 comprises PowerDVD and WinDVD.

When the active window of image capture system 100 does not belong to any of the predetermined applications, capture unit 32 captures (step S22) a desktop image shown on display 5 and stores the desktop image in predetermined folder 91 (step S24).

For example, when image capture system 100 has no application in execution or any active window, capture unit 32 utilizes a print screen function of OS 31 to capture a desktop image shown on display 5 and stores the desktop image in predetermined folder 91. Similarly, during progression of the image capture, user interface handler 33 may display a frame around the border of the desktop image shown on display 5 to mark a captured image area,

Capture unit 32 may name a captured image to be stored in folder 91 with a predetermined filename comprising text and a serial number. The text portion of the predetermined filename may be assigned through an input device of image capture system 100. When button 8 is triggered again, step S2 is repeated. The number portion of the filename of the next captured image may be automatically generated by increasing the serial number of the previous captured image.

In conclusion, an image capture system is a computer or an electronic device equipped with a dedicated button or switch for image capture. The image capture system may utilize a customized module or a built-in function of a predetermined application to capture and store an image from an image display area of an active window to a predetermined folder. The predetermined application may comprise an image media player application, a TV application, or an application for displaying realtime image data captured by a digital camera. Even though different applications may have different image capture functions, the image capture system can integrate these functions by determining system statuses and an image display area, capture images, and collectively store the captured image in a predetermined folder independent of the applications. The images in the folder may be attached to emails and sent to other computers.

The image capture method is different from conventional image capture methods in which a target area for image capture is determined manually or by utilizing a single generic image capture method.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image capture system capable of a plurality of image capture processes, comprising:
a button disposed on a surface of the image capture system;
a display capable of showing at least one window of a program executed by the image capture system;
a storage device coupled to the button and the display, storing a predetermined folder; and
a capture unit, when the button is activated, determining an active window of the image capture system and automatically performing a corresponding process selected from the image capture processes based on the determination, thus to capture and store an image shown on the display in the predetermined folder.

2. The system as claimed in claim 1, wherein the capture unit captures a desktop image shown on the display and stores the desktop image in the predetermined folder when the image capture system has no active window.

3. The system as claimed in claim 1, wherein each of a plurality of predetermined applications corresponds to one of the image capture processes.

4. The system as claimed in claim 3, wherein the capture unit captures a desktop image shown on the display and stores the desktop image in the predetermined folder when the active window does not belong to any of the predetermined applications.

5. The system as claimed in claim 3, wherein, when the active window belongs to a first predetermined application of the predetermined applications, the capture unit determines an image display area in the active window, captures and stores an image within the area in the predetermined folder.

6. The system as claimed in claim 5, wherein the capture unit captures and stores an image within the area in the predetermined folder utilizing the image capture function provided by the first predetermined application.

7. The system as claimed in claim 5, wherein the first predetermined application comprises an image media player application, a TV application, or a camera application for displaying realtime image data captured by a digital camera.

8. The system as claimed in claim 5, wherein the capture unit utilizes class name of the active window to retrieve the range of the image display area.

9. The system as claimed in claim 1, further comprising:
a user interface handler displaying a frame on the border of the image shown on the display when the button is activated.

10. An image capture system, comprising:
an input device for triggering an image capture request;
a display capable of showing at least one window of a program executed by the image capture system;
a storage device coupled to the input device and the display, storing a predetermined folder; and
a capture unit, when receiving the image capture request, determining whether an active window of the image capture system belongs to a first predetermined application of a plurality of predetermined applications, and, if so, utilizing an image capture function provided by the first predetermined application of the active window to capture and store an image shown on the display in the predetermined folder.

11. The system as claimed in claim 10, wherein the capture unit captures a desktop image shown on the display and stores the desktop image in the predetermined folder when the image capture system has no active window.

12. The system as claimed in claim 10, wherein the capture unit captures a desktop image shown on the display and stores the desktop image in the predetermined folder when the active window does not belong to any of the predetermined applications.

13. The system as claimed in claim 10, wherein, when the active window belongs to the first predetermined application, the capture unit determines an image display area in the active window, captures and stores an image within the area in the predetermined folder.

14. The system as claimed in claim 13, wherein the first predetermined application comprises an image media player application, a TV application, or a camera application for displaying realtime image data captured by a digital camera.

15. The system as claimed in claim 10, further comprising:
a user interface handler displaying a frame on the border of the image shown on the display when receiving the image capture request.

16. An image capture method, comprising:
storing a predetermined folder and a plurality of image capture processes in an image capture system;
when the image capture system receiving an image capture request, determining an active window of the image capture system; and
automatically performing a corresponding process selected from the image capture processes based on the determination, thus an image shown on a display is captured and stored in the predetermined folder.

17. The method as claimed in claim 16, wherein each of a plurality of predetermined applications corresponds to one of the image capture processes, further comprising when the active window does not belong to any of the predetermined applications, capturing a desktop image shown on the display and storing the desktop image in the predetermined folder.

18. The method as claimed in claim 17, further comprising:
when the active window belongs to a first predetermined application of the predetermined applications, determining an image display area in the active window; and
capturing and storing an image within the area in the predetermined folder.

19. The method as claimed in claim 18, further comprising utilizing an image capture function provided by the first predetermined application to capture and store the image within the area in the predetermined folder.

20. The method as claimed in claim 18, further comprising utilizing class name of the active window to retrieve the range of the image display area.
